(19) United States
(12) Patent Application Publication
(10) Pub. No.: US 2021/0173103 A1
(43) Pub. Date: Jun. 10, 2021

(54) COMPUTERIZED TOMOGRAPHY SYSTEM

(71) Applicant: LENSFREE LTD., Ra'anana (IL)

(72) Inventors: Zeev ZALEVSKY, Rosh HaAyin (IL); Doron AVRAHAM, Petach Tikva (IL)

(73) Assignee: LensFree Ltd., Ra'anana (IL)

(21) Appl. No.: 17/045,908

(22) PCT Filed: Apr. 8, 2019
(86) PCT No.: PCT/IL2019/050397

§ 371 Date: Oct. 7, 2020

Related U.S. Application Data
(60) Provisional application No. 62/655,298, filed on Apr. 10, 2018.

(51) Int. Cl. G01T 1/29; G02B 27/46

(52) U.S. Cl. CPC G01T 1/295; G01T 1/2928; G02B 27/46

(57) ABSTRACT

An imager unit and computerized tomography system are disclosed. The imager unit comprises a radiation source unit comprising at least one radiation source emitting selected radiation and configured to provide diffused radiation with general direction of propagation, and an image collection unit comprising aperture unit and detector array located downstream of the aperture unit with respect to said general direction of propagation. The aperture unit comprises a set of two or more aperture arrays each aperture array having a predetermined arrangement of apertures. The aperture unit is configured for utilizing said set of aperture arrays for collecting the radiation during corresponding collection time periods.

### TECHNOLOGICAL FIELD

The invention is in the field of radiology and medical imaging and is of particular relevance to computerized tomography imaging of patients.

### BACKGROUND

Computerized Tomography (CT) is an imaging technique utilizing X-ray imaging from a plurality of angular directions and enabling three-dimensional mapping of the scanned body. Generally, the conventional CT scanning techniques utilize a process of obtaining a plurality of X-ray scattering data (images) each taken from a different direction, and combining the collected data pieces, e.g. by Radon transformation, for generating three-dimensional model of the inspected body.

Each of the X-ray images is collected by directing a diverging beam of X-ray radiation toward the body from a selected angular direction, and collecting scattered radiation at opposite side of the body for generating image data indicative of the object. The image data pieces are effectively shadow of the object for illumination with X-ray radiation. Relation between the angle of divergence of the radiation source and size (aperture) of the detector array configured for collecting the scattered radiation define parameters of the so obtained image data.

Several techniques are known, enabling non-optical imaging with increased resolution and intensity, For example.

US 2017/0163961 describes method and system for imaging a region of interest with pinhole based imaging. The method comprising: collecting input radiation from the region of interest through a selected set of a plurality of a predetermined number of aperture arrays, each array having a predetermined arrangement of apertures and collecting the input radiation during a collection time period, wherein said selected set of the aperture arrays and the corresponding collection time periods defining a total effective transmission function of the radiation collection, generating image data from the collected input radiation, said image data comprising said predetermined number of image data pieces corresponding to the input radiation collected through the aperture arrays respectively, processing the image data pieces utilizing said total effective transmission function of the radiation collection, and determining a restored image of the region of interest. The set of aperture arrays is preferably selected such that said total effective transmission function provides non-null transmission for spatial frequencies being lower than a predetermined maximal spatial frequency.

US 2015/0381958 describes an imaging system configured for providing three-dimensional data of a region of interest. The system comprising: an optical unit and a control unit. The optical unit comprises a radiation collection unit and a detection unit. The radiation collection unit comprises at least two mask arrangement defining at least two radiation collection regions respectively, the mask arrangements are configured to sequentially apply a plurality of a predetermined number of spatial filtering patterns formed by a predetermined arrangement of apertures applied on radiation collected thereby generating at least two elemental image data pieces corresponding to the collected radiation from said at least two collection regions. The control unit comprising is configured for receiving and processing said at least two elemental image data pieces and determining a plurality of at least two restored elemental images respectively being together indicative of a three dimensional arrangement of the region being imaged.

### GENERAL DESCRIPTION

There is a need in the art for a novel configuration and operation technique for computerized tomography (CT) scanning enabling three-dimensional imaging of a body with increased resolution, while generally no increasing, and preferably decreasing radiation levels as compared to conventional CT techniques.

The present technique provides an imager module configuration, suitable for use in computerized tomography systems or in general imaging systems. The imager module comprising a radiation source unit, typically comprising a radiation source configured for generating radiation of predetermined frequency (wavelength range) and a diffuser unit located in path of emitted radiation and configured for diffusing radiation passing therethrough to thereby generate a broad beam of radiation having a general direction of propagation. The imager module further comprising an image collection unit comprising an aperture unit and detector array. Typically, the radiation source unit is located upstream of a sample (or body) to be inspected and the image collection unit is located downstream of the sample (body) along the general direction of propagation of radiation emitted from the radiation source unit.

The aperture unit is configured as a variable coded aperture (VCA) unit comprising a selected set of a predetermined number of aperture arrays, each array having a predetermined arrangement of apertures. Typically, the aperture unit comprises two or more or three or more aperture arrays having selected arrangement of aperture. The VCA unit is configured for image collection utilizing the different aperture arrays for collecting the radiation during corresponding collection time periods for each aperture array. The image data pieces collected by the different aperture arrays (generally two or more aperture arrays of the set) are being processed together in accordance with data on the aperture arrays and corresponding collection time periods for determining restored image data.

To this end the technique and the imager unit of the present invention provides for imaging of non-optical radiation, i.e. radiation where refraction optics cannot be used such as sonic or ultra-sonic waves, X-ray and Gamma radiation, and enabling high resolution imaging suitable for tomography and three-dimensional imaging. The present technique utilizes radiation source unit, configured for emitting radiation (e.g. X-ray, Gamma or ultrasonic radiation), a diffuser configured for introducing scattering to radiation transmitted therethrough, while maintaining a general direction of propagation. The image collection unit utilizes the concept of pinhole imaging, utilizing a set of pinhole/aperture arrays selected to provide high resolution imaging with increased energetic efficiency.

This technique is capable of providing non-optical imaging with optimized efficiency, in terms of energetic efficiency and imaging resolution, as compared to the conventional X-ray imagers. This is mainly due to the face that while the conventional non-optical imaging techniques (used for X-ray imaging e.g. in CT systems) utilizes radiation propagating from a radiation source toward a detector unit and shading, or partial shading, of the radiation by the objects/samples being imaged, the present technique provides imaging utilizing plurality of radiation components having slightly different direction of propagation. To this end, the diffuser used in the radiation source unit provides for scattering radiation introducing components having plurality of different spatial frequencies (or different directions of propagations) enabling proper imaging of an inspected body/sample.

Additionally, the image collection unit according to the present technique utilizes a set of aperture arrays, comprising a selected set of apertures/pinholes. The use of two or more apertures having certain distance between them provides for imaging with corresponding two or more points of view enabling extraction of three-dimensional image data. This enables reconstructions of three-dimensional image data utilizing an instance of image collection. More specifically, while conventional techniques in CT imaging require collecting X-ray shading imaged from a plurality of direction for reconstruction of three-dimensional image data of the inspected body, the present technique may provide certain three-dimensional reconstructions based on a single direction of image collection. This enables efficient scanning using reduced number of imaging directions and accordingly reduced radiation intensity as compared to conventional CT techniques. Such energy reduction may be by factor of 2 to 5 in accordance with the inspected body or body part.

Thus, according to a broad aspect, the present invention provides an imager unit comprising: radiation source unit comprising at least one radiation source emitting selected radiation and configured to provide diffused radiation with general direction of propagation, image collection unit comprising aperture unit and detector array located downstream of the aperture unit with respect to said general direction of propagation; the aperture unit comprises a set of two or more aperture arrays each aperture array having a predetermined arrangement of apertures, said aperture unit being configured for utilizing said set of aperture arrays for collecting the radiation during corresponding collection time periods.

The imager unit may further comprise object mount located between said radiation source and said image collection unit and configured for identifying suitable location for an object to be monitored.

According to some embodiments the imager unit may be configured to be mounted on a rotatable arm for imaging an object from a selected set of angular directions.

According to some embodiments the radiation source may be an ultra-sound source providing diffused ultra-sonic radiation. In some other configurations, the radiation source may be X-ray, Gamma or ultra-violet radiation source.

According to some embodiments the radiation source may further comprise a radiation shaping element configured for diffusing the remitted radiation.

The imager unit may further comprise one or more radiation encoding structures, the radiation encoding structures are configured with a periodic pattern having periodicity of spatial frequency greater with respect to resolution determined by at least one of aperture diameter and geometrical resolution of the detector array.

According to some embodiments the set of two or more aperture arrays may be configured with arrangement of apertures selected to provide total effective transmission function having non-null transmission for spatial frequencies lower than a predetermined maximal spatial frequency.

Generally, the aperture unit may be configured for operating said set of aperture arrays with corresponding collection time periods selected for optimizing transmission intensities for selected spatial frequencies.

According to some embodiments the imager unit may further comprise or is associated with a control unit comprising an image processing module, said image processing module is configured and operable for receiving image data pieces from said detector array, corresponding to radiation collection through each of said set of aperture array with corresponding collection time, and for processing said image data piece in accordance with total effective transmission function for determining a restored image data.

The control unit may further comprise a depth mode selection module, said depth mode selection module is configured and operable for utilizing said effective transmission function and defining a set of two or more depth resolved transmission function, said image processing module being configured for further determining corresponding two or more depth-relate restored image data pieces utilizing said depth resolved transmission function, thereby generating three-dimensional image data.

The control unit may further comprise a tomography module configured and operable for receiving restored image data pieces associated with data collected of a sample from a plurality of angular directions and determine a three-dimensional model of a sample.

According to some embodiments the imager unit may be configured for providing x-ray imaging during cardiac catheterization operation, enabling reduced radiation leakage. This configuration may eliminate, or at least significantly reduce radiation leakage toward medical personnel, increasing safety of cardiac catheterization operation.

According to some embodiments the image collection unit may be configured for detecting Gamma radiation, thereby enabling at least one of Positron-emission tomography (PET) and single photon emission computed tomography (SPECT).

According to one other broad aspect, the present invention provides a computerized tomography system comprising:

an imager unit mounted on a rotatable frame and configured to be rotated around a defined platform where a body to be inspected may be placed, the imager unit comprising:
(a) radiation source unit comprising at least one radiation source configured for generating high energy radiation of predetermined wavelength range, and a diffuser unit located in path of radiation emitted from said radiation source and configured for broadening width of radiation beam propagating toward said platform,
(b) an image collection unit located downstream of said platform with respect to direction of radiation propagation from said source and comprising an aperture (pinhole) unit, and a detector array unit located along path of radiation propagation from said source through said aperture unit;
   said aperture unit comprising a selected set of a plurality of a predetermined number of aperture arrays, each array having a predetermined arrangement of apertures, said aperture unit being configured for utilizing said set of aperture arrays for collecting the radiation during corresponding collection time periods.

According to some embodiments, the aperture unit may comprise a set of aperture arrays having arrangement of apertures selected to provide total effective transmission function having non-null transmission for spatial frequencies lower than a predetermined maximal spatial frequency.

The aperture unit may be configured for operating said set of aperture arrays with corresponding collection time periods selected for optimizing transmission intensities for selected spatial frequencies.

According to some embodiments the system may further comprise, or is associated with, a control unit comprising an image processing module, said image processing module is configured and operable for receiving image data pieces from said detector array, corresponding to radiation collection through each of said set of aperture array with corresponding collection time, and for processing said image data piece in accordance with total effective transmission function for determining a restored image data.

The control unit may further comprise a depth mode selection module, said depth mode selection module is configured and operable for utilizing said effective transmission function and defining a set of two or more depth resolved transmission function, said image processing module being configured for further determining corresponding two or more depth-relate restored image data pieces utilizing said depth resolved transmission function, thereby generating three-dimensional image data.

According to some embodiments the system may further comprise a motor unit connected to said rotating frame and a control unit comprising an angular selection module, said angular selection module is configured and operable for operating said motor and rotating said frame into a set of plurality of angular directions, wherein said image unit is configured for obtaining image data pieces is one or more of said angular directions.

The control unit may further comprise a tomography module configured and operable for receiving restored images associated with said plurality of angular directions and determine a three-dimensional model of a sample.

According to some embodiments the system may be configured for providing x-ray imaging during cardiac catheterization operation, enabling reduced radiation leakage.

According to some embodiments the image collection unit may be configured for detecting Gamma radiation, thereby enabling at least one of Positron-emission tomography (PET) and single photon emission computed tomography (SPECT).

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates an imager unit suitable for use on computerized tomography system according to some embodiments of the invention;

FIG. 2 exemplifies imaging technique utilizing a plurality of apertures;

FIG. 3 illustrates radiation source unit including radiation source and diffuser element according to some embodiments of the invention;

FIGS. 4A and 4B exemplify radiation encoding pattern enabling to obtain depth resolved information and super resolution according to some embodiments of the invention;

FIGS. 5A to 5F show imaging results of a radiation source sample according to some embodiments of the present invention compared to convention X-ray imaging;

FIGS. 6A to 6C show simulated tomographic reconstruction of three-dimensional simple object; FIG. 6A shows the object structure, FIG. 6B shows reconstructed object using the convention technique with 8 angular directions, and FIG. 6C shows reconstructed object using the technique of the invention with 3 angular directions;

FIGS. 7A to 7C show simulated tomographic reconstruction of three-dimensional slightly complex object; FIG. 7A shows the object structure, FIG. 7B shows reconstructed object using the convention technique with 15 angular directions, and FIG. 7C shows reconstructed object using the technique of the invention with 10 angular directions;

FIGS. 8A to 8C show X-ray object reconstruction using the present technique based on single angular direction;

FIGS. 9A to 9H show raw detector data and reconstructed images according to the present technique from angular directions of 0, 45, 90 and 135 degrees;

FIG. 10 shows tomographic reconstruction of an object using the image data pieces of FIGS. 9B, 9D, 9F and 9H; and

FIGS. 11A and 11B exemplify imaging using the present technique as compared to conventional X-ray imaging

FIGS. 12A to 12K show additional experimental setup and corresponding results, FIG. 12A shows the setup configuration, FIG. 12B illustrates different angles for imaging, FIGS. 12C, 12E, 12G and 12I show the relative orientation of the object with respect to the different angles, FIGS. 12D, 12F, 12H and 12J show corresponding reconstructed images in accordance with point of view, and FIG. 12K shows an image of the fully reconstructed model based on all four angular imaging orientations;

FIGS. 13A to 13C shows additional experimental result imaging two nails at selected distance and orientation, FIG. 13A shows an image of reconstructed model obtained from 72 viewing angles, FIG. 13B shows a cross section graph of the nails and FIG. 13C summarize the object profile from the reconstruction;

FIGS. 14A to 14D show images of a Gamma source using conventional single pinhole technique for 18 seconds (FIG. 14A) and 42 seconds (FIG. 14B), and raw (FIG. 14C) and reconstructed (FIG. 14D) images of the Gamma source collected within 18 seconds;

FIGS. 15A to 15C show section of images of a Gamma source; FIGS. 15A and 15B show images acquires by single pinhole imaging with respectively 18 and 42 seconds of exposure, FIG. 15C sows reconstructed image section collected using the present technique within 18 seconds total exposure; and FIGS. 16A to 16C show images of a Gamma source collected through single pinhole of diameters 2 mm (FIG. 16A) and 4.45 mm (FIG. 16B) and reconstructed image according to the present technique collected using VCA with pinholes of diameter of 2 mm (FIG. 16C).

### DETAILED DESCRIPTION OF EMBODIMENTS

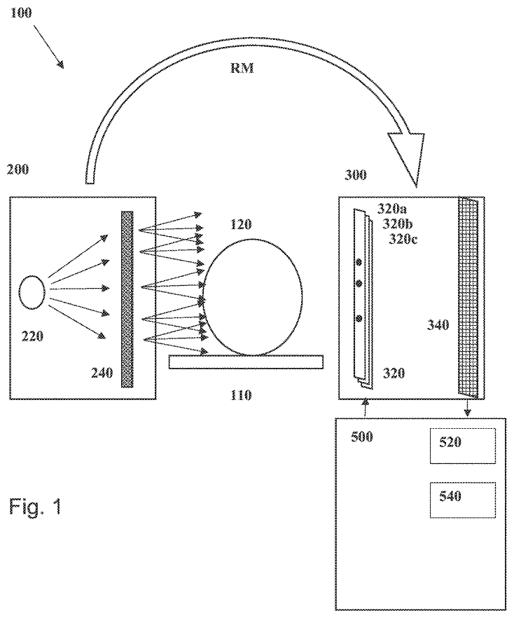

As indicated above, the present technique utilizes variable coded aperture (VCA) imaging techniques for optimizing tomographic imaging with reduced radiations as compared to the conventional techniques. Reference is made to FIG. 1 illustrating an imager unit 100, including a radiation source unit 200 and image collection unit 300 and configured for imaging an object 120 typically located on a sample mount 110. The radiation source unit 200 generally includes a radiating source 220 configured for emitting radiation (e.g. X-ray, Gamma radiation, or in some embodiments ultra-sonic waves) and a radiation shaping unit 240 located in general path of radiation propagation between the radiating source 220 and the image collection unit. The radiation shaping unit 240 generally includes a diffuser element and may also include an encoding unit configured for patterning the radiation field with a periodic wavefront pattern as described in more details further below. Typically, the radiation source unit 200 also includes suitable walls, or barrier arrangement, for preventing radiation leaks. Also, the radiation source unit may include a shutter unit configured to selectively open and close the radiation source unit 200 from emitting radiating for imaging. The walls/barrier and shutter unit are not specifically shown in FIG. 1 for simplicity of the figure.

The image collection unit 300 is positioned at an opposite side of the object 120 along path of radiation propagation from the radiation source unit 200. The image collection unit 300 includes a variable coded aperture (VCA) unit 320 including a set of aperture arrays, e.g. 320a-320c, and a detector array 340 configured for collecting radiation components passing through the VCA unit 320 and generate corresponding one or more pieces of respective image data (raw image data). The VCA unit 320 is configured for selectively using the different aperture arrays for collecting radiation impinging for corresponding collection times. For example, when three aperture arrays are used, acquisition process of a single image generally includes a first period of image potion acquisition using aperture array 320a, a second period of acquisition of image portion using aperture array 320b and a third period of image portion acquisition using aperture array 320c. Generally, the VCA unit 320 includes a set of aperture arrays, each having an arrangement of apertures positioned in at least partially non-periodic arrangement. Each array is used for a selected image acquisition time portion to provide desire image intensity and radiation level.

Generally, the set of aperture arrays 320a-320c is selected to provide total effective transmission function, of the set of aperture arrays, having non-null transmission for spatial frequencies lower than a predetermined maximal spatial frequency. More specifically, the set of aperture arrays is generally configured such that the total number of apertures is selected to allow desired radiation intensity within exposure time to provide sufficiently bright image, and that arrangement of arrays in the different aperture arrays have different transmission functions. It should be noted that generally transmission function of an arrangement of two or more apertures are characterized by one or more spatial frequencies (within range of transmission) having zero transmission. Accordingly, the aperture arrays are selected such that each array have zero transmission for different spatial frequencies, thereby providing effective total transmission function that is non-zero for all spatial frequencies within the resolution limits. Such resolution limit is determined by dimension of the apertures.

Generally, in some embodiments of the invention, the set of aperture arrays may be configured in accordance with selected parameters of imaging as follows. Determining a dimension of the pinholes (pinhole/aperture diameter) in accordance with locations of object plane or object platform 110, location of image plane/detector array 340 and desired maximal resolution for imaging. Determining a desired total number of apertures used in the VCA unit 320 based on image brightness, energetic efficiency, and aperture diameter. Determining a range of spatial frequencies for which the VCA unit 320 provides effective transmission up to resolution limit. Selecting arrangement of a first aperture array, the arrangement includes one or more apertures of the desired dimension in a selected arrangement. Determining transmission function of the aperture arrangement of the first aperture array and identifying one or more spatial frequencies for which transmission of the first aperture array is below a predetermined threshold, thereby defining a first set of spatial frequencies. Selecting arrangement of one or more additional aperture arrays, including one or more apertures of the desired dimension in a selected arrangement different from that of the first aperture array. The additional aperture arrays are configured such that aperture arrangement of each array provides transmission of at least some of the first set of spatial frequencies. Generally, the additional one or more aperture arrays are selected, such that for each spatial frequency that has zero transmission by one array, one or more other arrays have non-zero transmission, to thereby enable transmission of all spatial frequencies within the resolution limits. The selection process of aperture arrays may proceed providing three or more aperture arrays, wherein a total number of apertures divided by a total number of arrays provides a factor for said desired brightness per time unit.

The selected set of aperture arrays 320a-320c in combination with general information one exposure time ratio between the arrays define corresponding transmission function. More specifically, the transmission function F(u,v) of each aperture array, with respect to spatial frequencies (u,v) can be estimated by

F(u,v)=Σₙ₌₁^{N}Σₘ₌₁^{N} exp[−2πi(udₙ^{(x)}+vdₘ^{(y2)})] (equation 1)

where N is the number of apertures in the array and d^{(x)} and d^{(y)} indicate locations of the apertures in the array. The total effective transmission function may be determined based on the transmission functions of the different aperture arrays and data on respective exposure times as

G(u,v)=Σₗ₌₁^{L}F^{l}(u,v)·tₗ (equation 2)

where L is the number of aperture arrays used and tₗ is the exposure time of array l. As indicated above, the transmission function of a single aperture array F(u,v) generally provides zero transmission to one or more spatial frequencies due to interference of light components transmitted through the different apertures. The set of aperture arrays (320a-320c) is selected such that each aperture array has zero transmission for different spatial frequencies, providing the total effective transmission function G(u,v) with non-zero transmission for all frequencies within the resolution limits defined by dimension of a single aperture (typically the minimal aperture size). Selection of the exposure time tₗ for each aperture array enables further modification of the total effective transmission function, e.g. to provide greater transmission for certain spatial frequencies and adjust the collected image in accordance with desired features of the sample.

Generally, the imager unit 100 may include or be associated with a control unit 500. The control unit includes at least an image processing module 520 configured for receiving image data piece and processing the collected data pieces to provide reconstructed image data. To this end, the control unit 500 may also include, or be connectable with a storage utility 540. The storage utility 540 carries pre-stored data on transmission functions F^{l}(u, v) of the different aperture arrays 320a-320c, as well as additional data such as selected exposure time schemes etc.

The processing module 520 may operate for determining/selecting time exposure scheme and accordingly obtain data on total effective transmission function G(u,v) as described above. The processing module generally utilizes the total effective transmission function for processing collected image data pieces for determining reconstructed image data. Such processing may for example utilize Fourier reconstructions of the collected image data in accordance with the total effective transmission function by:

S(u,v)=[Σₗ₌₁^{L}S^{l}_{array}(u,v)·tₗ]G⁻¹(u,v) (equation 3)

where S(u, v) is the reconstructed image data in Fourier plane, S^{l}_{array} is the image data collected by aperture array l, tₗ is the corresponding collection time for array l and G⁻¹ is inverse of the total effective transmission function G(u,v) in the spatial frequency domain.

In this connection it should be noted that system 100 may be configured for operating based on predetermined exposure time protocol (i.e. a predetermined set of exposure times tₗ for the set of aperture arrays), or for operating based on selected set of exposure times tₗ, selected in accordance with sample characteristics, operator preferences etc. Accordingly, the control unit 500 may be pre-provided with data on one or more variations of the total effective transmission function G(u,v) associated with one or more exposure time protocols stored in the storage utility 540. Alternatively or additionally, the storage utility 540 may be pre-loaded with data on the transmission function F^{l}(u, v) of each aperture array, the processing module 520 may be configured and operable for determining the total effective transmission function G(u,v) in accordance with selected exposure times for each aperture array 320a-320c.

Generally, the imager unit 100 may be mounted on a rotatable frame, configured to be rotated along a path RM about specified location of the body 120 (selected axis). The rotatable frame is configured for varying orientation of the imager unit 100 with respect to the inspected body 120, or generally with respect to the sample carrying platform 110, enabling imaging of the inspected body 120 from a plurality of angular directions to allow tomography and construction of three-dimensional representation of the body 120. This enables collection of image data from a plurality of angular directions for reconstruction of three-dimensional image data, e.g. as used on X-ray based Computerized Tomography (CT systems).

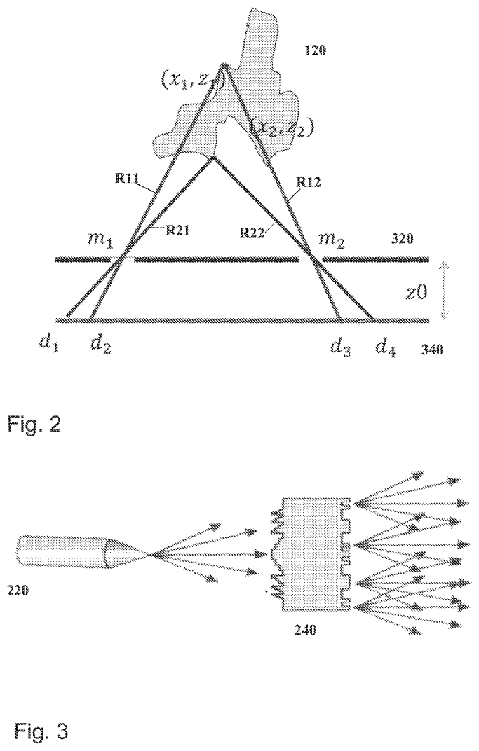

As indicated above, the use of aperture arrays of the VCA unit enables image reconstruction that extracts three-dimensional image data while collecting the image data from a single angular direction. This can be achieved as the aperture arrays 320a-320c include a number of spaced apart apertures effectively providing slightly different imaging orientations. To this end, the technique may utilize processing of collected image data while considering relative locations of the apertures in each aperture array. FIG. 2 illustrates one technique for extracting three-dimensional data based on imaging with a single angular direction and FIG. 3 illustrates one other technique utilizing encoded pattern of the radiation.

As shown in FIG. 2, radiation components R11 and R12 associated with scattering from one point (x1,z1) of the object 120 are transmitted through the aperture array 320 and reach the detector array 340 forming collected signals at certain points marked as d2 and d3. Radiation components R21 and R22 associated with a different location (x2,z2) of the object 120 are transmitted through the aperture array 320 reach the detector array 340 at positions d1 and d4.

As shown in the figure, radiation components associated with or scattered from points on the object 120 located at different distances from the aperture array 320, generate different images on the detector associated with the distance between the respective positions from the aperture array. This effect is associated with the multiplicity of apertures in each aperture arrays effectively imaging the object 120 from several directions. More specifically, as shown in FIG. 2, positions (x1,z1) and (x2,z2), located respectively at distances z1 and z2 from the aperture array actually see the different apertures of the array in different angular directions. This effect may be considered as a result of varying magnification M for different objects in accordance when being imaged through pinholes at different distanced therefrom.

The processing module 520 may utilize predetermined, pre-stored, information about imager system dimensional and expected distances of objects and certain desired depth resolution, and corresponding different effective transmission functions associated with different distances within the object. The processing module 520 may further utilizes the different transmission function data pieces for reconstruction of image data collected in each angular position for providing three-dimensional data from each angular direction of imagine.

Thus, the different apertures of the aperture arrays provide slightly different point of view of the inspected object 120, thereby effectively providing stereoscopic imaging. Using three-dimensional image reconstructions, for each angular direction enables that system to provide high resolution three-dimensional image date of an object, while requiring reduced number of images as compared to conventional X-ray based CT systems. The reduction in required images enables the technique of the invention to provide high resolution three-dimensional modeling of body part or organs while reducing the required radiation level by a factor of 2-5 in accordance with the required resolution.

Reference is made to FIG. 3 illustrating an exemplary configuration of the radiation source unit 200. As indicated above, the radiation source unit 200 includes a radiating source 220 configured for emitting radiation (e.g. X-ray, Gamma radiation, or in some embodiments ultra-sonic waves) and a radiation shaping unit 240. In the example of FIG. 3 the radiation shaping unit 240 includes a diffuser element configured for scattering radiation passing therethrough to provide substantially uniform radiation field. The diffuser element of the radiation shaping unit 240 may be configured as Dammann grating or diffusing crystal element and selected in accordance with the radiation wavelength used.

In this connection, the imager unit described herein is generally configured for imaging of the inspected object (120) using radiation scattered from the object. This is as compared to the conventional X-ray and CT imaging techniques that typically allow radiation to pass through the object and detect transmission of radiation through the sample while not collecting radiation scattered from the object. It should further be noted that the use of scattering radiation is typically needed for imaging. This is since in absence of scattering radiation collection, points on the object might not provide any radiation components that are collected through apertures of the aperture array 320 and detected by the detector array.

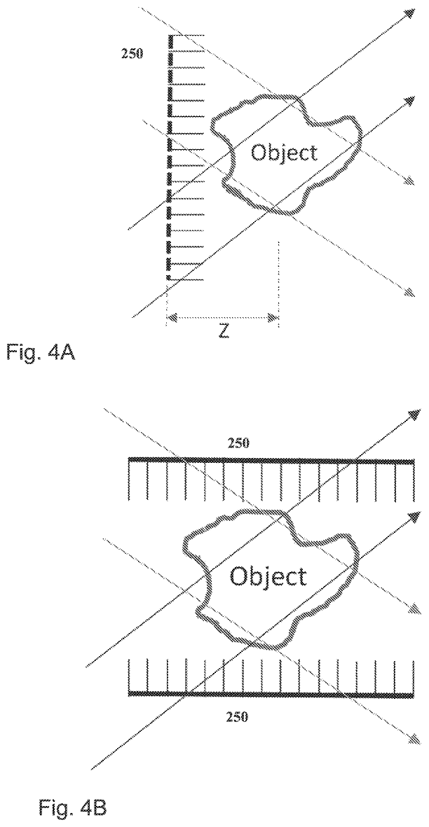

The imaging resolution provided by the imager unit described herein is determined in accordance with two main factors, diameter of the apertures in the aperture arrays 320 and geometric resolution of the detector array 340 (number of pixels). The imager unit 100 may also be configured for providing improved resolution (super resolution) imaging using one or more radiation encoding elements, e.g. associated with the radiation shaping unit 240. Reference is made to FIGS. 4A and 4B exemplifying the radiation encoding elements 250. FIG. 4A illustrates transversal super-resolved configuration and FIG. 4B illustrates axial super-resolved configuration. The encoding element 250 may typically be configured as a periodic array of radiation blocking/absorbing lines or wires (e.g. made of lead (Pb)). The periodicity of the element is selected to be higher that the imager defined resolution, i.e. distance between wires is smaller than the resolution defined by the size of the apertures in the aperture arrays 320.

The radiation encoding element 250 provides a preselected known pattern encoding to radiation passing through before imaging of the object through the aperture array. Utilizing the encoding pattern of the radiation encoding element 250 while collecting images of the object from different directions, provides for effectively multiplying object projections from the different observation angles (angular directions for imaging) by shifted encoding structure. More specifically, the projections of the object for different observation angles generate relative shifts between the projected object and the static encoding pattern. This provide object imaging in accordance with the formula

b[x−Z·sin(α)]o(x) (equation 4)

where b[x] is the periodic encoding structure, o(x) is the object structure and Z represents the distance between the encoding structure and the center of the three-dimensional object.

Using imaging from two or more different angular directions (a) and the high periodicity of the radiation encoding element 250, provides super-resolved imaging by processing the collected image data in accordance with the encoded pattern. The use of the high frequency radiation encoding element 250 applies spatial encoding having features finer with respect to imaging resolution limits. This high spatial frequency encoding is effectively converted to by captures as lower frequency pattern by multiplication with the sample structure and due to the periodicity thereof. Accordingly, the collected image data includes low frequency features associated with the pattern of the radiation encoding element 250. Collection of several image data pieces, from different directions with respect to the object and processing of the image data pieces by applying decoding pattern associated with multiplication of the image data pieces and the pattern of the radiation encoding element 250 restores the high spatial frequency features in the correct, original, spectral locations.

The example of FIG. 4A shows transversal super-resolution configuration in which the radiation encoding element 250 is located in path of radiation propagating toward the object. The example of FIG. 4B illustrated axial super-resolution configuration in which radiation encoding element 250 is configured as three-dimensional encoding medium. More specifically, the object is located within the encoding medium and from each angle of observation the encoding medium 250 encodes its depth information. In this configuration the angular variation of the encoding pattern is formed using a plurality of apertures in the aperture arrays 320. Image portions collected through each aperture in the array are associated with imaging of the object via slightly shifted (parallax) direction. More specifically, the encoding medium 250 provides that different shifted image portions associated with radiation collection through different apertures of the aperture arrays 320 are encoded with different pattern (in accordance with direction of propagation of radiation toward the respective aperture, enabling the processing module to extract depth super-resolved three-dimensional image of the object.

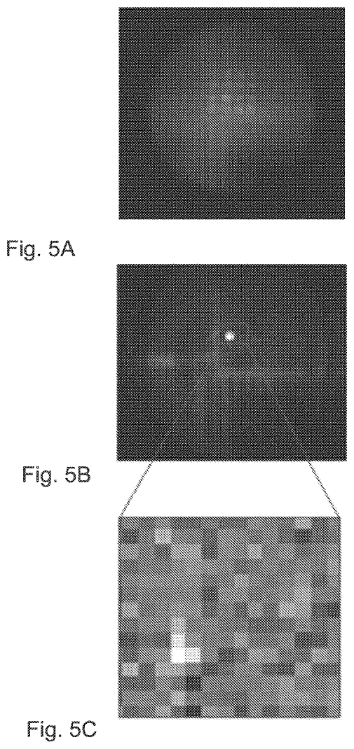

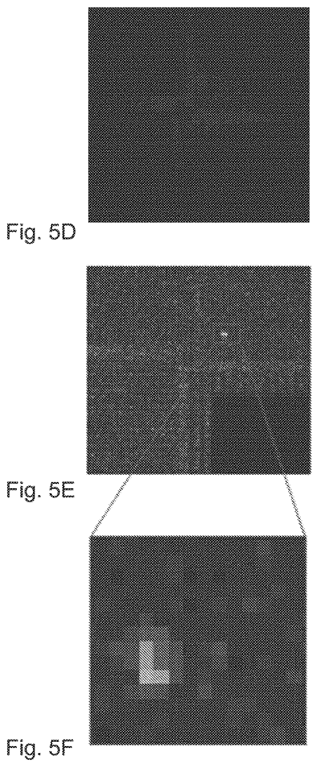

Reference is made to FIG. 5A to 5F showing experimental results comparing energetic efficiency and radiation reduction for imaging using the present technique as compared to the conventional collimators array used in the commercially available CT systems. FIG. 5A shows raw image data collected via a set of three aperture arrays, each having an arrangement of apertures selected as described above; FIG. 5B shows reconstructed image data using the present technique, FIG. 5C shows enlarged region centered around radiation pick associated with radiation source; FIG. 5D shows single aperture image data; FIG. 5E shows image collected by the conventional collimator plates imaging techniques; and FIG. 5F shows enlarged region centered around the radiation source as collected by the conventional technique.

The experimental data was collected using SPECT camera unit using the following parameters:
Experimental Gamma system: GE Infinia NM
Nuclear detector: ⅜″ (9.5 mm) crystal thickness, 59 circular PMT's—53×3″ (76 mm) and 6×1.5″ (38 mm).
Usable field of view: 54×40 cm±0.5 cm.
Intrinsic spatial resolution: 3.9 mm
Pinhole tungsten insert diameter (δ): 2 mm; acceptance angle: 75°
Gamma source plate: 50×50 cm, isotope: C0-57, 10 mCi.
Tested objects: Gamma bar phantom resolution target with resolutions of: ⅛″ (3.18 mm), 5/32″ (3.97 mm), 3/16″ (4.77 mm), ¼″ (6.35 mm), lead piece, radioactive point source (isotope: Co-57, 6.36 μCi) as hot lesion object, coins as cold lesion object.
Scan time: 60 sec

In addition to the collected image data, number of counts of the nuclear detector indicate energetic efficiency and accordingly reduction in radiation used for imaging. In this connection, the imaging with conventional collimator plates was obtained with 180 counts on the detector (for the 60 sec scan time). The VCA imaging unit of the present technique obtained the image data of FIG. 5A (later reconstructed to provide FIG. 5B) with 2100 counts of the nuclear detector (for similar scan time). Thus, for similar amount of radiation impinging on the object, the present technique collected and used about ten times more radiation intensity for generating the image data. This enables generating higher brightness (and/or contrast) images for similar radiation exposure or reduce radiation exposure to obtain images of similar brightness as compared to the conventional techniques. Further, as shown in FIGS. 5A-5C and 5E-5F, the image quality in terms of contract may be greater using the present VCA technique.

The energetic efficiency of the present technique can be described as compared to the conventional X-ray collimator techniques where the imaging is based on projections of an object while avoiding collection of scattered radiation. To this end the radiation profile used in conventional collimator imaging technique is assumed to be of Gaussian angular distribution with standard deviation (STD) of NA₀ (in accordance with the radiation energy, source structure etc.). The angular transmission range that passes through the collimator is defined here as Δβ. Assuming N_{c} collimator holes and each has diameter of d_{c}, and cross section area A₀ of the radiation is provides expression for the energetic transmission of a collimator plate as:

$${η}_{c} = \frac{( {N}_{c} π {d}_{c}^{2} / 4 )}{{A}_{0}} \cdot {( \frac{1}{\sqrt{2 π} N {A}_{0}} {\int }_{- Δβ / 2}^{+ Δ β / 2} exp ( - {α}^{2} / 2 N {A}_{0}^{2} ) d α )}^{2} \approx \frac{( {N}_{c} π {d}_{c}^{2} / 4 )}{{A}_{0}} \cdot ( \frac{Δ {β}^{2}}{N {A}_{0}^{2}} ) \qquad ( equation 5 )$$

In this connection, it is assumed that the collimator is used in order to perform “projection”, i.e. 1:1 imaging.

As for the present technique, assuming that each aperture transmits all the angular distribution and do not block angles (providing Δβ=NA₀), and that the aperture arrays set has total number of Nh aperture with diameter of do for each aperture. Given similar imaging integration time and minification/magnification factor of M. Therefore, the energetic efficiency for imaging using the present technique may be provided by:

$${η}_{h} = \frac{{N}_{h} \cdot π {d}_{c}^{2} / 4}{{A}_{0}} \cdot {M}^{2} \qquad ( equation 6 )$$

It should be noted that the energetic efficiency in this case may be greater than 1 (or than 100%) due to the minification/magnification factor M. This is because the energetic efficiency is defined as the amount of energy arriving per same integration time per same detection area. Thus, if the same energy arrives to smaller area due to minification it can produce an “amplification” factor of the energy and to have efficiency larger than 1.

Accordingly, based on equations 5 and 6, the present technique may provide energetic efficiency improvement given as ratio between the efficiencies provided by these equations providing

$$\frac{{η}_{h}}{{η}_{c}} = \frac{{d}_{h}^{2}}{{d}_{c}^{2}} \cdot \frac{{N}_{h}}{{N}_{c}} \cdot \frac{N {A}_{0}^{2}}{Δ {β}^{2}} \cdot {M}^{2} \qquad ( equation 7 )$$

For simplicity, assuming aperture diameter that is approximately similar to collimator holes, dₕ≈d_{c}, providing similar geometrical resolution, and assuming that total number of aperture and collimator holes Nₕ≈N_{c}, the energetic efficiency may be increased by two orders of magnitude resulting from minification/magnification M and angular ratio of radiation collection NA₀.

Accordingly, the radiation shaping element 240 shown in FIG. 1 is preferably used for increasing effective scattering of radiation, e.g. enabling to increase scattering energy to 30% and more. This enables increased energetic efficiency of imaging as well as contrast and brightness. Generally however, the use of diffuser element 240 for increased scattering is more effective at high energies (e.g. greater that 40 KeV or greater 12 KeV). This is since at lower energies, the atomic scattering provided by the radiation source 220 and by object itself 120 is sufficiently high for efficient imaging. Accordingly, the use of VCA imager of the present technique may provide increase energetic efficiency, per angular direction of imaging, by a factor in the range of 2 and in some configurations by a factor of 10, and in some configuration by a factor of 100.

As indicated above, the present technique also enables reduction in number of images required for reconstruction of three-dimensional model of the monitored object or body. More specifically, as indicated above the present technique enables obtaining of three-dimensional data using image data collected from single angular direction. In addition to reducing number of required images for tomographic reconstruction, certain adjustments of the tomographic processing may be in place.

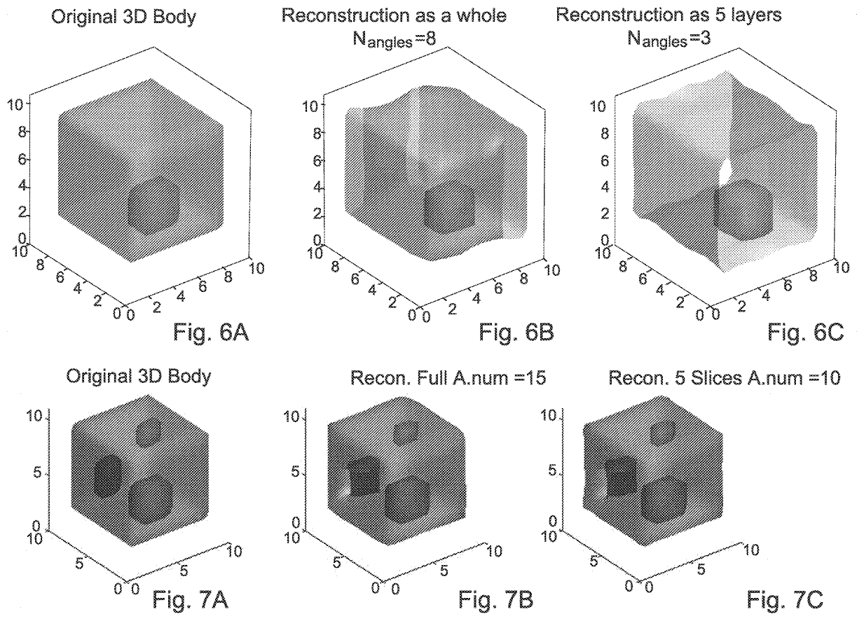

Reference is made to FIGS. 6A-6C and 7A-7C showing simulated results of object reconstruction of the present technique and conventional technique. FIGS. 6A and 7A show two objects used for reconstruction, FIGS. 6B and 7B show simulated object model reconstructed using conventional Radon and inverse Radon transformations using 8 and 15 angular projections respectively, and FIGS. 6C and 7C show simulated object model reconstructed using image data collected from 3 and 10 angular directions respectively using the present technique. The objects shown in FIGS. 6A and 7B are formed of 10×10×10 points of information and include three-dimensional internal structure differing in interaction with radiation impinging thereon. The more complex object of FIG. 7A was reconstructed using greater number of angular directions both in the conventional technique and in the technique of the invention as compared to the simpler object of FIG. 6A.

For reconstruction, the present technique utilizes a series of partial three-dimensional data pieces and tomography processing to determine a three-dimensional model. As indicated above, each image data collected from certain angular direction contains partial three-dimensional data therewithal. Processing two or more depth layers of the partial three-dimensional data pieces collected from a series of directions using localize Radon and inverse Radon transformations allows retrieving three-dimensional model of the object. Generally, the present technique enables three-dimensional reconstruction of object model with half the number of angular projections, further reducing the radiation required for obtaining suitable tomographic reconstruction.

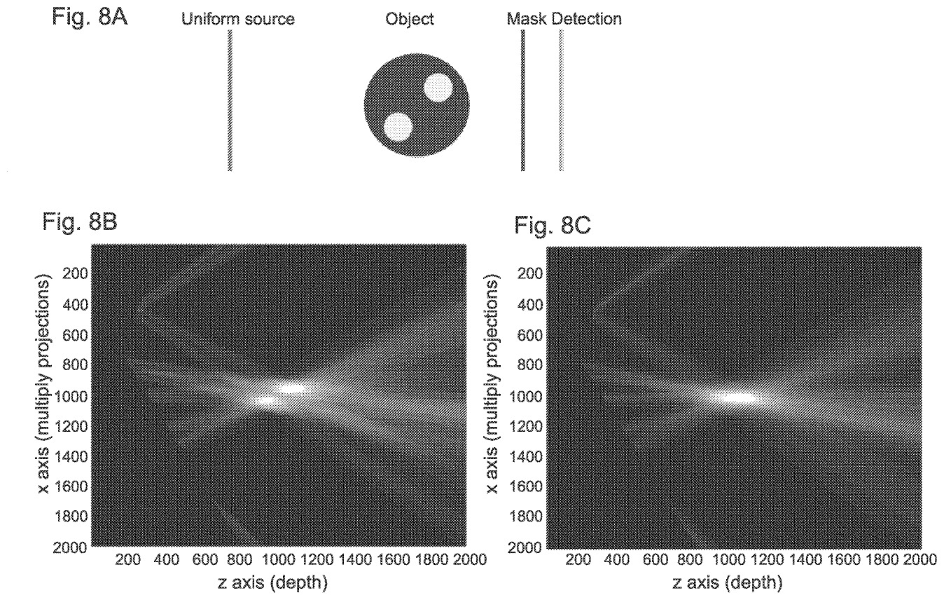

As shown for the examples of FIGS. 6A-6C and 7A-7C, the present technique improves reconstruction of three-dimensional data by 50% for complex objects while in simple object the improvement may reach to 270%. Generally, according to the present technique, selection of the angular directions for imaging the object may enable three-dimensional reconstruction with reduced number of images, providing image data with selected accuracy with reduced radiation impinging on the object. More specifically, obtaining several images from different angular directions having large variation between them, e.g. using angular directions of −30, 0 and 30 degrees or −15, 0 and 15 degrees as compared to −5, 0 and 5 degrees, enables optimization of the reconstruction with reduced number of angular directions. Reference is made to FIGS. 8A to 8D illustrating an additional experimental setup and corresponding results. FIG. 8A illustrates the setup including diffused radiation source, and object formed by a disk with absorption μ1 and two smaller disks with absorption μ2, the radiation is collected by a mask forming VCA arrays and detector array. FIG. 8B shows reconstructed image based on single angular direction of 0 degrees as exemplified in FIG. 8A, and FIG. 8C shows reconstructed image from a single angular direction of 45 degrees. As described above, the present technique enables certain three-dimensional reconstruction using image data collected from a single angular direction. Such reconstruction is shown in FIG. 8B where both of the smaller disks are visible within the large disk of the object. However, in some objects having complex structure, or when internal structure hiding other features of the object, additional reconstruction might be preferred. Such case is shown in FIG. 8C where the angular direction of 45 degrees views the object when one of the smaller disks is blocking the other. In this case additional angular directions are needed for effective reconstruction.

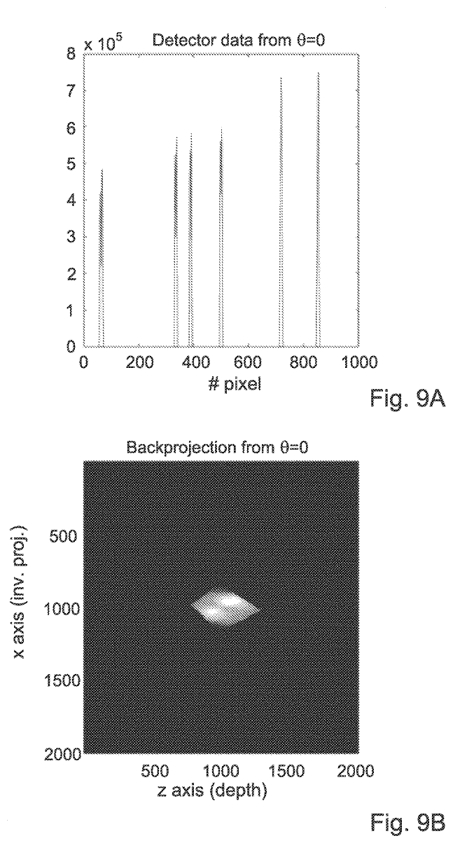

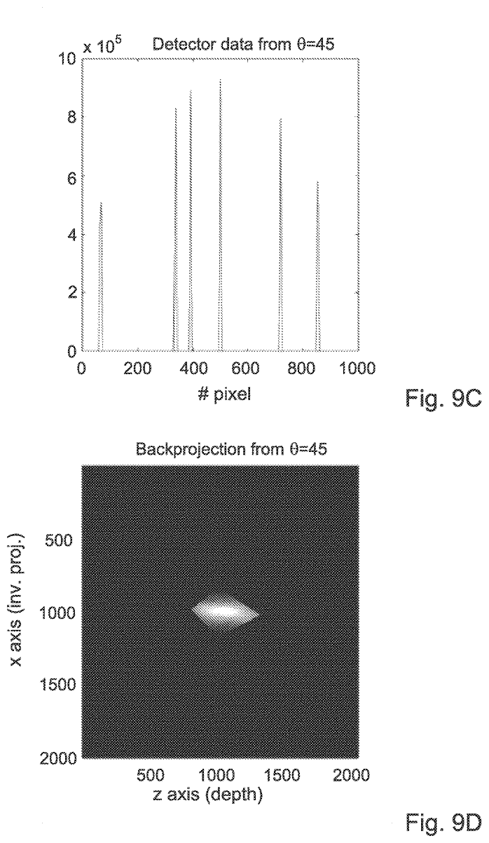

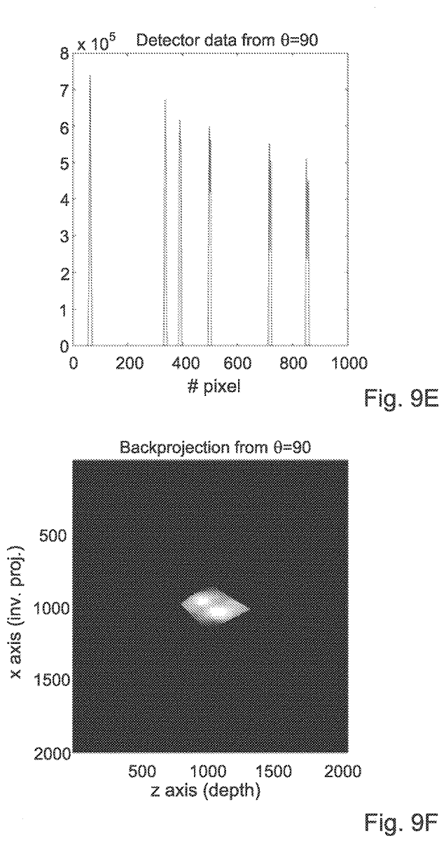

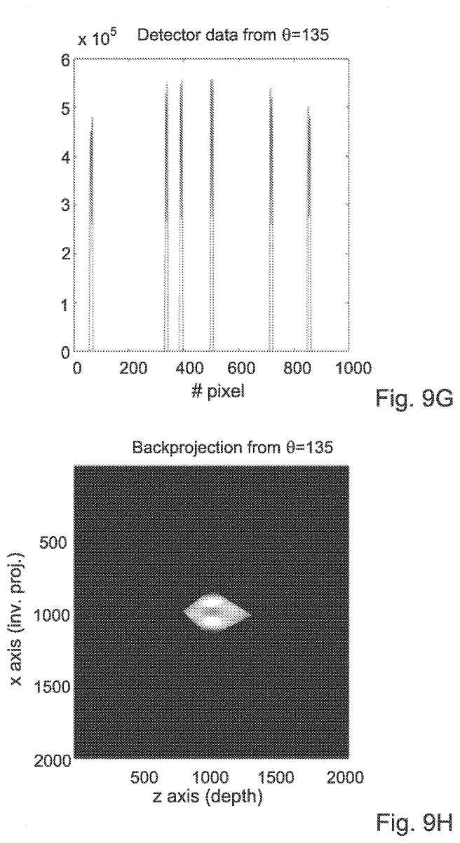

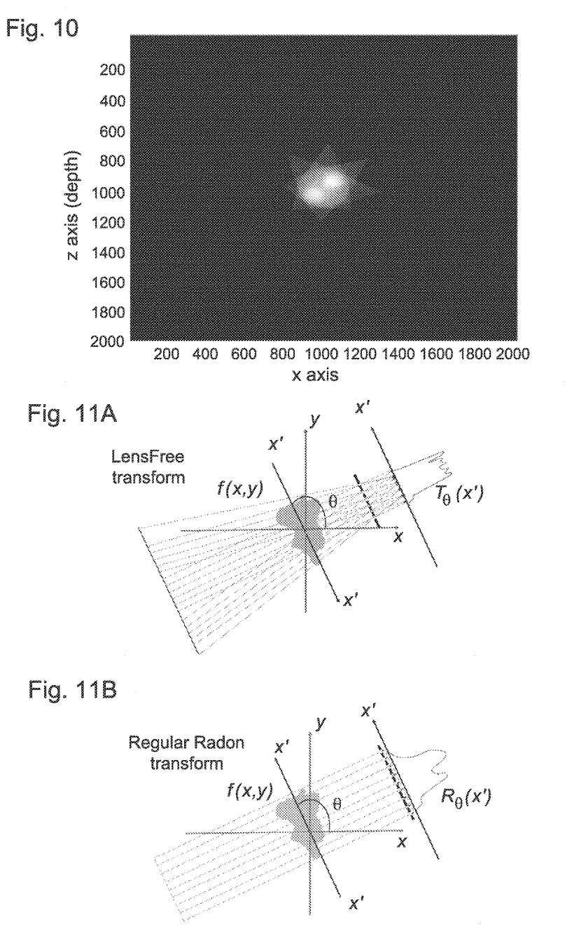

To this end additional angular directions were used for imaging and reconstruction. FIGS. 9A to 9H show detector data and partially reconstructed images for angular directions of 0, 45, 90 and 135 degrees. FIGS. 9A and 9B provide results for 0 degrees, FIGS. 9C and 9D correspond to 45 degrees, FIGS. 9E and 9F correspond to 90 degrees and FIGS. 9G and 9H provide results for 135 degrees. Complete reconstruction of the object structure using localized Radon and inverse Radon transforms is shown in FIG. 10. As shown in FIGS. 9A, 9C, 9E and 9H, the raw detector data includes duplications of the image, with certain overlap, caused by radiation collection through a set of aperture arrays, being changed during the collection time. The reconstructed images, each reconstructed based on data collected from a single angular direction, are shown in FIGS. 9B, 9D, 9F and 9H. As described, these reconstructed images provide certain depth resolution based on the reconstructed processing and the fact that the data is collected through two or more apertures having different locations with respect to the object. Complete object reconstruction is shown in FIG. 10 where the internal structure of the object is efficiently resolved. It should be noted that the complete reconstruction is determined using four different angular directions only.

Thus, the present technique utilizes imager unit configured for imaging one or more selected objects using a set of aperture arrays, where each image is collected through the different aperture arrays of the set. This configuration may simplify tomography processing and enables to determine complete three-dimensional structure using reduced number of angular directions. This is provided by reconstruction of each image, from single angular direction, to provide certain depth resolved information. Accordingly, the present technique is advantageous for imaging using high energy radiations such as X-ray and Gamma radiation, due to the energetic efficiency enabling to expose the body (sample, object or patient) to lower amounts of radiation for similar or higher image quality. Generally however, the present technique may be used for any imaging technique including visible light and ultrasound imaging.

In this connection it should be noted that ultrasound tomographic imaging may utilized substantially similar configuration as described above, with a main difference relating to selection of material that are acoustic absorbers rather than radiation absorbers. Such ultrasound tomographic imaging may provide high resolution depth imaging of biological tissue without the need for radiation exposure and may be of high relevant for early detection of breast cancer.

FIGS. 11A and 11B show schematic illustration exemplifying imaging using the imager unit of the present technique as compared to conventional X-ray imaging as used in computerized tomography (CT) systems. As described above, the present technique utilizes a plurality of transmission masks, being changed during imaging for each angular direction. Further the transmission masks may be varied within the scanning system in accordance with imaging objectives for improving detection of selected features. This may be done using variation of the mask patterns as well as variation to exposure time for each aperture array. Reconstruction of image data for each angular direction is based on the aperture array configuration. However, the tomographic reconstructions using plurality of angular direction is based on the image data pieces and need not use data on the aperture arrays used for imaging. It should also be noted that the present technique utilizes scattered radiation for imaging where direct projections may generally be block by the aperture array of the collection unit.

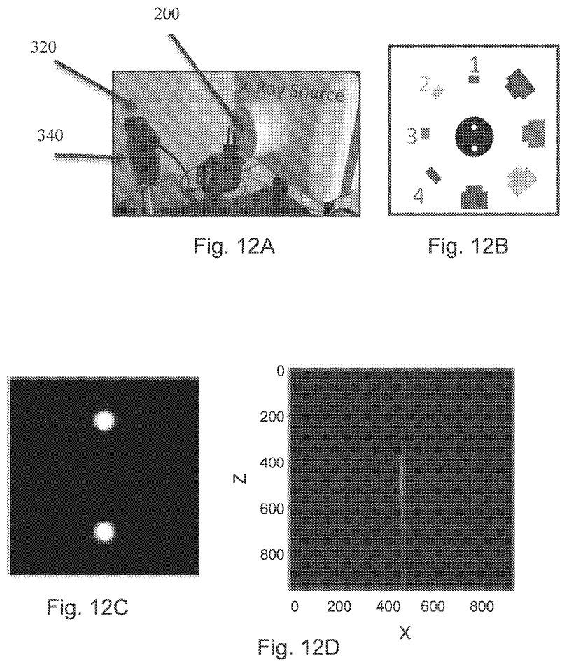

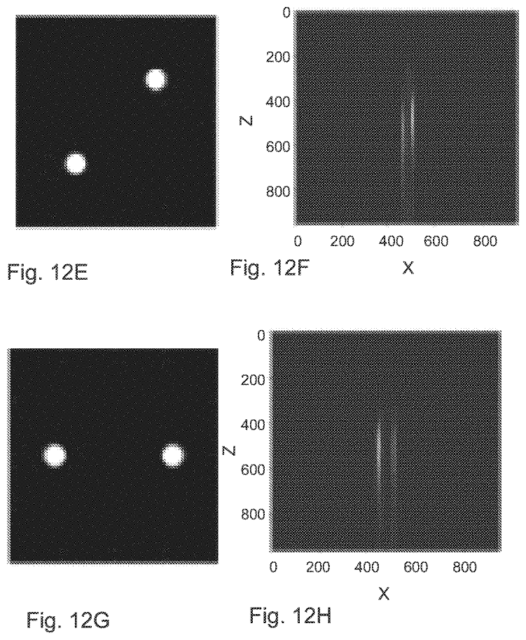

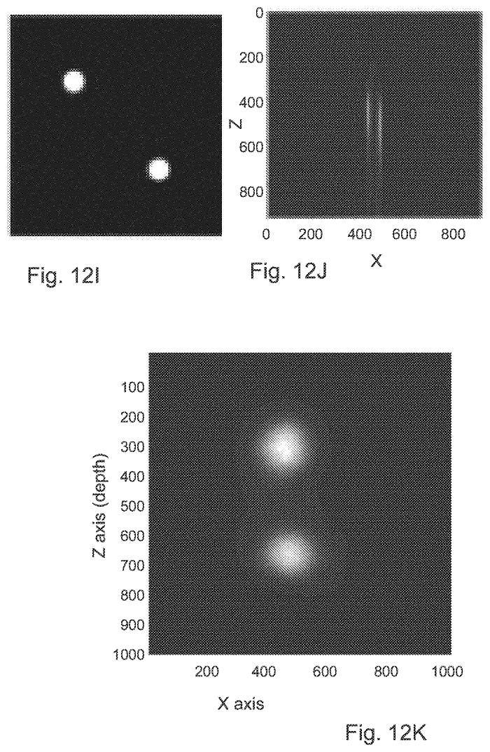

Reference is made to FIGS. 12A-12K showing an additional experimental setup and corresponding results. FIGS. 12A and 12B show configuration of the experiment setup including diffused X-Ray radiation source 200, an object formed by two nails accommodate on an object platform, the radiation is collected by an aperture unit 320 formed by a VCA array including three aperture arrays and a flat detector array 340. FIG. 12B shows the different orientations used in this setup for imaging the object. As shown, the detector 340, VCA mask 320 and X-Ray source 200 are rotated in a circular path around the object enabling imaging of the inspected object from a plurality of angular directions. FIGS. 12C to 12J show relative orientation of the object with respect to imaging direction and respective reconstructed image. More specifically, FIGS. 12C, 12E, 12G and 12I show the relative orientation of the object and FIGS. 12D, 12F, 12H and 12J show the corresponding reconstructed images in accordance with point of view. FIG. 12K shows an image of the fully reconstructed model using all four angular imaging orientations.

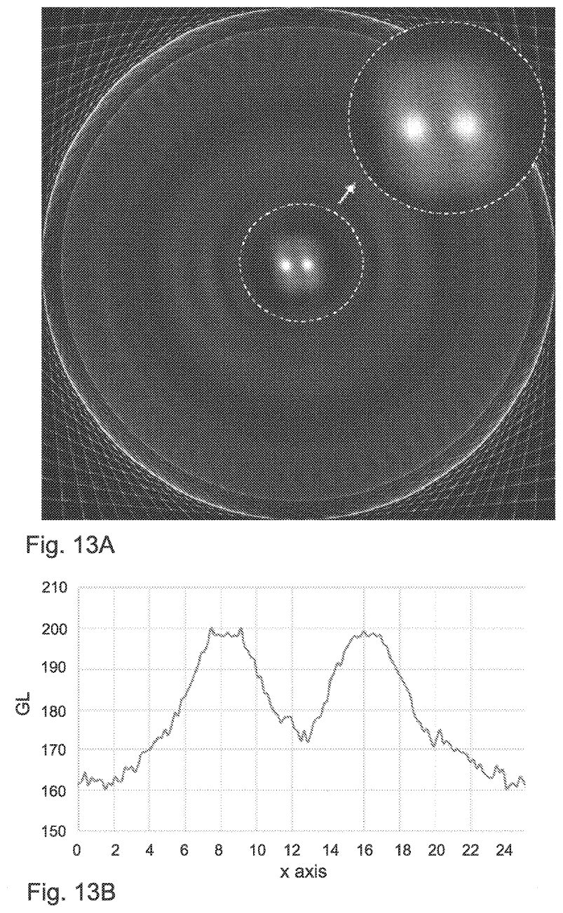

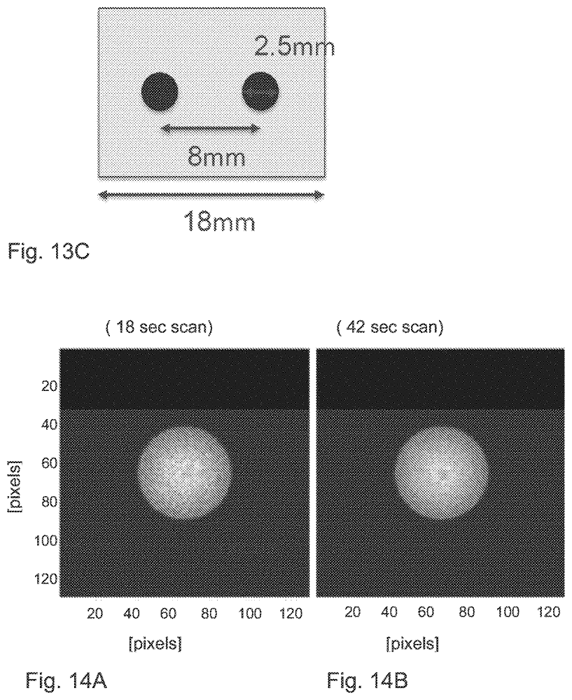

FIGS. 13A-13C show additional experimental results following similar setup as shown in FIG. 12A. In this example the two nails of the object are placed inside rectangle plastic holder having dimensions of 18×20 mm. The nails head diameter is 2.5 mm FIG. 13A shows image of reconstructed model obtained from 72 viewing angles, FIG. 13B shows a cross section graph of the nails and FIG. 13C summarize the object profile from the reconstruction. As can be seen from this experimental example, the present technique is highly robust and can provide high imaging accuracy of relatively low contrast objects and environmental conditions.

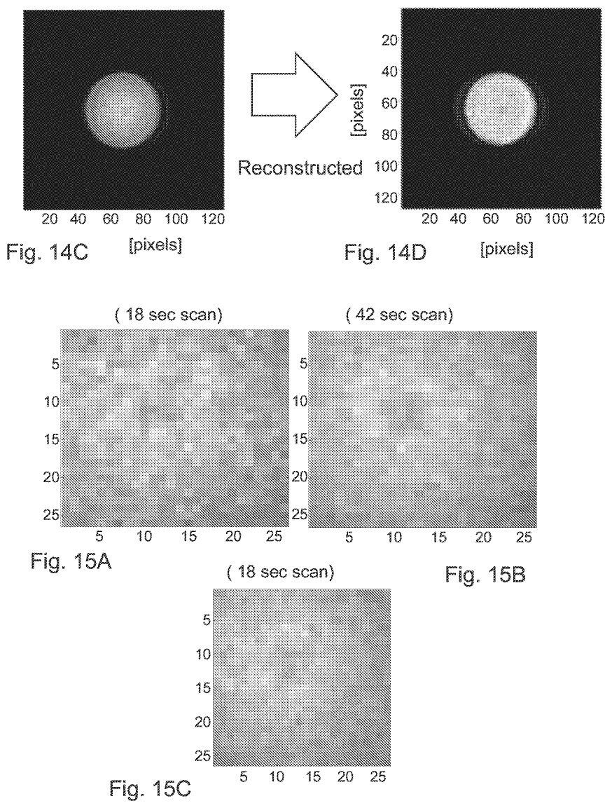

Reference is made to FIGS. 14A to 14D, 15A to 15C and 16A to 16C showing additional exemplary experimental results indicating energetic efficiency, time reduction, SNR and resolution improvement provided by the present technique. FIGS. 14A and 14B show images of a Gamma source using conventional single pinhole technique for 18 seconds and 42 seconds respectively, FIGS. 14C and 14D show respectively raw and reconstructed images of the Gamma source collected within 18 seconds. As shown, the reconstructed image if FIG. 14D allows visible improvement in brightness as compared to single pinhole imaging.

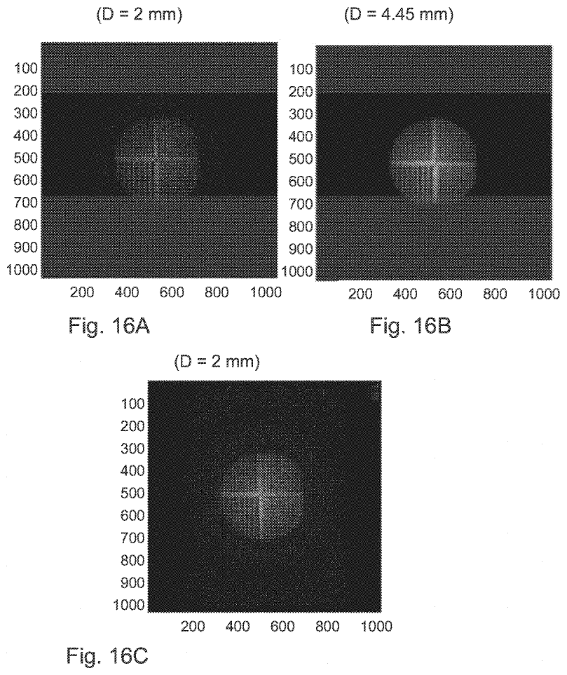

FIGS. 15A to 15C show section of images of a Gamma source. FIGS. 15A and 15B relate to conventional single pinhole imaging with respectively 18 and 42 seconds of exposure, FIG. 15C sow reconstructed image section collected using the present technique within 18 seconds total exposure. As shows, within 18 seconds, the present technique enables providing signal to noise ratio as obtained within 42 seconds exposure in the conventional technique.

FIGS. 16A to 16C exemplify resolution improvement in imaging of a patterned Gamma source. FIGS. 16A and 16B show images of a Gamma source collected through single pinhole of diameters 2 mm (FIG. 16A) and 4.45 mm (FIG. 16B). FIG. 16C shows reconstructed image collected using the present technique with VCA having pinholes of similar diameters of 2 mm. As shown in FIGS. 16A and 16B, the used of large diameter provides increased brightness at the cost of reduces image resolution. This is while the image of FIG. 16C provides higher brightness while not reducing the image resolution of the patterned Gamma source.

Thus, as indicated above, the present technique utilizes imaging with varying coded aperture for enabling high efficiency imaging using optical and non-optical radiation. The present technique enables improved imaging system that can be used for high efficiency, low radiation tomographic imaging.

1. An imager unit comprising: radiation source unit comprising at least one radiation source emitting selected radiation and configured to provide diffused radiation with general direction of propagation, image collection unit comprising aperture unit and detector array located downstream of the aperture unit with respect to said general direction of propagation; the aperture unit comprises a set of two or more aperture arrays each aperture array having a predetermined arrangement of apertures, said aperture unit being configured for utilizing said set of aperture arrays for collecting the radiation during corresponding collection time periods.

2. The imager unit of claim 1, further comprising selected object mount located between said radiation source and said image collection unit and configured for identifying suitable location for an object to be monitored.

3. The imager unit of claim 1, configured to be mounted on a rotatable arm for imaging an object from a selected set of angular directions.

4. The imager unit of claim 1, wherein the radiation source is an ultra-sound source providing diffused ultra-sonic radiation.

5. The imager unit of claim 1, wherein the radiation source emits X-ray, Gamma or ultra-violet radiation.

6. The imager unit of claim 5, wherein the radiation source further comprises a radiation shaping element configured for diffusing the remitted radiation.

7. The imager unit of claim 5, further comprising radiation encoding structure, the radiation encoding structure is configured with a periodic pattern having periodicity of spatial frequency greater with respect to resolution determined by at least one of aperture diameter and geometrical resolution of the detector array.

8. The imager unit of claim 1, wherein said set of two or more aperture arrays having arrangement of apertures is selected to provide total effective transmission function having non-null transmission for spatial frequencies lower than a predetermined maximal spatial frequency.

9. The imager unit of claim 1, wherein said aperture unit is configured for operating said set of aperture arrays with corresponding collection time periods selected for optimizing transmission intensities for selected spatial frequencies.

10. The imager unit of claim 1, further comprising a control unit comprising an image processing module, said image processing module is configured and operable for receiving image data pieces from said detector array, corresponding to radiation collection through each of said set of aperture array with corresponding collection time, and for processing said image data piece in accordance with total effective transmission function for determining a restored image data.

11. The imager unit of claim 10, wherein said control unit further comprising a depth mode selection module, said depth mode selection module is configured and operable for utilizing said effective transmission function and defining a set of two or more depth resolved transmission function, said image processing module being configured for further determining corresponding two or more depth-relate restored image data pieces utilizing said depth resolved transmission function, thereby generating three-dimensional image data.

12. The imager unit of claim 11, wherein said control unit further comprises a tomography module configured and operable for receiving restored image data pieces associated with data collected of a sample from a plurality of angular directions and determine a three-dimensional model of a sample.

13. The imager unit of claim 1, configured for providing x-ray imaging during cardiac catheterization operation, enabling reduced radiation leakage.

14. The imager unit of claim 1, wherein the image collection unit is configured for detecting Gamma radiation, thereby enabling at least one of Positron-emission tomography (PET) and single photon emission computed tomography (SPECT).

15. A computerized tomography system comprising:
an imager unit mounted on a rotatable frame and configured to be rotated around a defined platform where a body to be inspected may be placed, the imager unit comprising:
(a) radiation source unit comprising at least one radiation source configured for generating high energy radiation of predetermined wavelength range, and a diffuser unit located in path of radiation emitted from said radiation source and configured for broadening width of radiation beam propagating toward said platform,
(b) an image collection unit located downstream of said platform with respect to direction of radiation propagation from said source and comprising an aperture (pinhole) unit, and a detector array unit located along path of radiation propagation from said source through said aperture unit;
said aperture unit comprising a selected set of a plurality of a predetermined number of aperture arrays, each array having a predetermined arrangement of apertures, said aperture unit being configured for utilizing said set of aperture arrays for collecting the radiation during corresponding collection time periods.

16. The system of claim 15, wherein said aperture unit comprises a set of aperture arrays having arrangement of apertures selected to provide total effective transmission function having non-null transmission for spatial frequencies lower than a predetermined maximal spatial frequency.

17. The system of claim 15, wherein said aperture unit is configured for operating said set of aperture arrays with corresponding collection time periods selected for optimizing transmission intensities for selected spatial frequencies.

18. The system of claim 15, further comprising a control unit comprising an image processing module, said image processing module is configured and operable for receiving image data pieces from said detector array, corresponding to radiation collection through each of said set of aperture array with corresponding collection time, and for processing said image data piece in accordance with total effective transmission function for determining a restored image data.

19. The system of claim 18, wherein said control unit further comprising a depth mode selection module, said depth mode selection module is configured and operable for utilizing said effective transmission function and defining a set of two or more depth resolved transmission function, said image processing module being configured for further determining corresponding two or more depth-relate restored image data pieces utilizing said depth resolved transmission function, thereby generating three-dimensional image data.

20. The system of claim 15, further comprising a motor connected to said rotating frame and a control unit comprising an angular selection module, said angular selection module is configured and operable for operating said motor and rotating said frame into a set of plurality of angular directions, wherein said image unit is configured for obtaining image data pieces is one or more of said angular directions.

21-23. (canceled)
